(19) United States
(12) Patent Application Publication
(10) Pub. No.: US 2007/0277200 A1
(43) Pub. Date: Nov. 29, 2007

(54) Broadcast receiving apparatus and method for providing interactive broadcasting

(75) Inventor: Jeon-hoon Park, Gwanak-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/711,056

(22) Filed: Feb. 27, 2007

(30) Foreign Application Priority Data
Mar. 31, 2006 (KR) 10-2006-0029805

(51) Int. Cl. G06F 3/01

(52) U.S. Cl. 725/39

(57) ABSTRACT

Provided are a broadcast receiving apparatus and method for providing interactive broadcasting. The broadcast receiving apparatus includes a broadcast signal processor that processes an interactive broadcast signal which contains interactive content, a user interface unit, via which a user's input signal is received, a controller that sets key maps so that interactive content elements included in the interactive content correspond to user input keys included in the user interface unit, and a picture composition unit that composes a picture which provides the interactive content under control of the controller. The picture composition unit assigns signs corresponding to the user input keys to each of the interactive content elements, respectively, and composes the picture including the interactive content elements, for which the key maps are set, and the signs. Accordingly, even if a broadcast receiver does not include a touch screen, it is possible to easily use the interactive broadcast content.

### CROSS-REFERENCE TO RELATED PATENT APPLICATION

This application claims the priority of Korean Patent Application No. 10-2006-0029805, filed on Mar. 31, 2006 in the Korean Intellectual Property Office, the disclosure of which is incorporated herein in its entirety by reference.

### BACKGROUND OF THE INVENTION

1. Field of the Invention

Methods and apparatuses consistent with the present invention relate to broadcast receiving, and more particularly, to providing interactive broadcasting.

2. Description of the Related Art

Interactive broadcasting generally provides a menu for interaction with video, or a link to a specific video location on a screen of a terminal, via which a user can select a desired function by using an input device. Examples of interactive broadcasting are digital multimedia broadcasting, which provides data with interactive functions included in general audio/video broadcasting, web information broadcasting, which provides interactive functions through web functions, traffic information broadcasting, which allows elements of traffic information to be individually selected, etc.

If a receiving terminal includes an input device, such as a touch screen, which allows a user to directly select a menu on a screen, the user can very easily select an interactive menu provided in interactive broadcasting. However, broadcast terminals generally include simple input keys, not a touch screen. Therefore, even if interactive broadcasting is supplied to a broadcast terminal that uses general input keys instead of a touch screen, the user cannot effectively use interactive broadcasting.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a broadcast receiving apparatus and method for providing interactive broadcasting that allows a user to easily use the interactive broadcasting by key inputting without a touch screen.

According to an aspect of the present invention, there is provided a broadcast receiver for providing interactive broadcasting, the broadcast receiver includes a broadcast signal processor that processes an interactive broadcast signal which contains interactive content, a user interface unit via which a user's input signal is received, a controller that sets key maps so that interactive content elements included in the interactive content correspond to user input keys included in the user interface unit, and a picture composition unit that composes a picture which provides the interactive content under control of the controller. The picture composition unit assigns signs corresponding to the user input keys to each of the interactive content elements, respectively, and composes the picture including the interactive content elements, for which the key maps are set, and the signs.

When the user's input signal selecting one of the interactive content elements from the user interface unit is received, the controller may interactively process the interactive content element selected in response to the user's input signal.

Whenever the user's input signal requesting a change of a broadcast channel or a broadcast service is received from the user interface unit, the controller may set a key map for each of the interactive content elements.

Whenever interactive content for a current broadcast service is changed, the controller may set the key map for each of the interactive content elements.

The user interface unit may comprise an access button that receives a user's input signal requesting the picture containing the interactive content elements, for which the key maps are set; and a selection keypad that receives a user's input signal selecting one of the interactive content elements included in the picture.

The user interface unit may comprise a speech recognition unit which recognizes speech requesting the picture including the interactive content elements, for which the key maps are set, or selecting one of the interactive content elements included in the picture, and transmits the speech to the controller.

According to another aspect of the present invention, there is provided a broadcast receiving method of providing interactive broadcasting, the method comprising processing interactive broadcast signals containing interactive content; setting key maps so that each of interactive content elements included in the interactive content corresponds to one of user input keys included in the user interface unit; and composing a picture that includes the interactive content elements, for which the key maps are set, and signs corresponding to the user input keys, which are assigned to the interactive content elements, respectively.

### BRIEF DESCRIPTION OF THE DRAWINGS

The above and other aspects of the present invention will become more apparent by describing in detail exemplary embodiments thereof with reference to the attached drawings in which:

FIGS. 1A and 1B illustrate a broadcast receiver that provides interactive broadcasting according to an exemplary embodiment of the present invention;

FIG. 2 is a block diagram of a broadcast receiver that provides interactive broadcasting according to an exemplary embodiment of the present invention;

FIG. 3 is a flowchart illustrating a method of providing interactive broadcasting according to an exemplary embodiment of the present invention; and

FIG. 4 is a flowchart illustrating a method of providing interactive broadcasting according to another exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

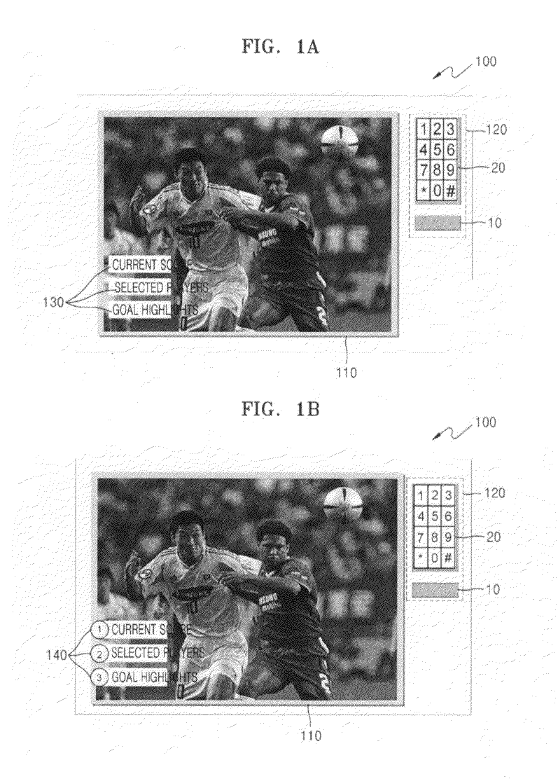

FIGS. 1A and 1B illustrate a broadcast receiver 100 that provides interactive broadcasting according to an exemplary embodiment of the present invention. The broadcast receiver 100 includes a display screen 110 and a keypad 120. The keypad 120 includes an access button 10, and a selection keypad 20 on which number keys are arranged.

Referring to FIG. 1A, interactive content elements 130 are displayed together with video data on the display screen 110. In an exemplary embodiment of the present invention, when a user presses the access button 10 on the display screen 110 displaying the interactive content elements 130 as illustrated in FIG. 1A, a key map is set to provide interactive content elements which are given a number 140, for example, as illustrated in FIG. 1B. In an exemplary embodiment of the present invention, the key map is set for each interactive content element, and when each key of the selection keypad 20 is pressed, key code for executing a corresponding interactive content element is defined in the key map.

The user can select the interactive content elements on the display screen 110 by using the number keys on the selection keypad 20. For example, the user can select an element “goal highlights” by pressing the number key 3 of the selection keypad 20 on the display screen 110 illustrated in FIG. 1B. When the element “goal highlights” is selected, video including goal scoring scenes of a sports broadcast that is being provided is interactively provided to the user.

Accordingly, even if the broadcast receiver 100 does not include a touch screen, a key map is set for each interactive content element, and therefore, the user can select the number 140 via the selection keypad 20 to select a desired interactive content element, and view interactive broadcasting. In FIGS. 1A and 1B, the access button 10 and the selection keypad 20 are separately constructed, but the access button 10 may be present on a specific location of the selection keypad 20, and the keypad 120 may be of any shape.

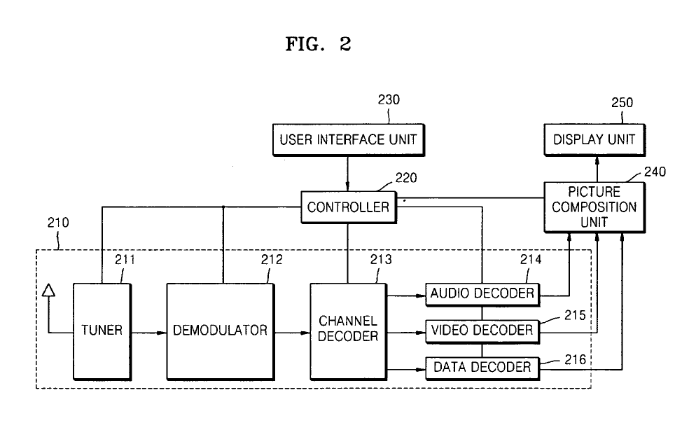

FIG. 2 is a block diagram of a broadcast receiver that provides interactive broadcasting according to an exemplary embodiment of the present invention. Referring to FIG. 2, the broadcast receiver includes a broadcast signal processor 210, a controller 220, a user interface unit 230, a picture composition unit 240, and a display unit 250.

The broadcast signal processor 210 processes an interactive broadcast signal that contains interactive content. The interactive broadcast signal contains audio content, video content, and interactive content that are transmitted according to an MPEG-2 stream method in which the content is multiplexed to an encoded stream, or transmitted according to an Internet Protocol (IP) packet method. The broadcast signal processor 210 separates the audio content, the video content, and the interactive content from the interactive broadcast signal transmitted according to an interactive broadcast transmission method, and decodes the separated content.

As illustrated in FIG. 2, the broadcast signal processor 210 may include a tuner 211, a demodulator 212, a channel decoder 213, an audio decoder 214, a video decoder 215, and a data decoder 216 so as to process a digital multimedia broadcast (DMB) signal.

An orthogonal frequency division multiplexing (OFDM) modulated signal is supplied to the tuner 211 and demodulated into a DMB transmission frame by the demodulator 212. The channel decoder 213 creates a service list by parsing fast information channel (FIC) data contained in the DMB transmission frame. The FIC data contains a service encoding parameter and packetized information. Therefore, the FIC data is parsed to reveal the type of a service to be provided and manners in which data of the service is encoded and packetized.

The controller 220 provides the channel decoder 213 with information indicating a service whose data is to be selected and decoded. The information for selecting a service is input via the user interface unit 230 by using a keypad or a similar device. Also, the controller 220 provides the audio decoder 214, the video decoder 215, and the data decoder 216 with a command that instructs a corresponding service to be decoded. The audio decoder 214, the video decoder 215, and the data decoder 216 output a decoded audio service, a decoded video service, and a decoded data service and transmit them to the picture composition unit 240, respectively. Then, the picture composition unit 240 composes a picture according to a command given from the controller 220. Then, the picture composition unit 240 outputs the picture to the display unit 250 in response to a control signal from the controller 220.

The data decoder 216 decodes interactive content, and supplies the decoded interactive content to the controller 220 and the picture composition unit 240. When interactive content is transmitted in the form of a Binary Format for Scenes (BIFS) stream that is data to describe a picture, the BIFS stream is parsed to obtain information needed to compose the picture that includes the interactive content. The information needed to compose the picture specifies the construction of the interactive content, for example, the location of the decoded interactive content on the picture. The information may be received from a broadcasting transmitting terminal. Otherwise, the information was stored in the broadcast receiver and the stored information can be used to compose the picture.

The controller 220 can parse the BIFS stream and control the picture composition unit 240 according to the interactive content. The picture composition unit 240 receives the information needed to compose the picture from the controller 220, and composes the picture including the interactive content.

Also, the controller 220 checks the interactive content elements, and sets a key map such that the interactive content elements correspond to user input keys included in the user interface unit 230. When composing the picture including the interactive content elements, for which the key maps are set, the picture composition unit 240 makes the picture such that signs or numbers corresponding to user input keys are assigned to the interactive content elements. The picture is provided to the user, and thus, the user can execute the interactive content by using the user input keys of the user interface unit 230.

The controller 220 normally controls the picture composition unit 240 to make a picture with interactive content included in interactive broadcasting by using the parsed BIFS data. When receiving the user's input signal requesting use of the interactive content from the user interface unit 230 during which the picture is being made with the interactive content, the controller 220 may set a key map for each interactive content element and control the picture composition unit 240 to make a picture that includes the interactive content elements, which are given signs corresponding to user input keys according to the key map as described above.

The key map for each interactive content element may be updated if needed. If the user changes broadcast channels, broadcast services, or interactive content included in a broadcast service is changed, the details of the interactive content are also changed.

Thus, whenever receiving the user's input signal requesting a change of a broadcast channel or a broadcast service from the user interface unit 230, the controller 220 may set a key map for each interactive content element. More specifically, when receiving the user's input signal requesting a change of a broadcast channel, the controller 220 controls the broadcast signal processor 210 so that the broadcast signal processor 210 receives interactive broadcasting via the changed broadcast channel and processes it. Then, the controller 220 sets a key map for each processed interactive content element. When receiving the user's input signal requesting a change of a broadcast service, the broadcast signal processor 210 may process interactive content included in the changed broadcast service under control of the controller 220, and the controller 220 may set a key map for each interactive content element.

Also, whenever interactive content for a current broadcast service is changed, the controller 220 may set a key map for each interactive content element. For example, when an element “goal highlights” of the interactive content is provided during a latter part of a sports broadcast service illustrated in FIG. 1B, a picture may be constructed such that a key map is also set for the element “goal highlights”. As described above, since key maps set for interactive content are updated if necessary, the user can easily determine and use available interactive content.

As illustrated in FIGS. 1A and 1B, the user interface unit 230 that receives the user's input signal includes an access button for receiving the user's input signal in order to receive the picture including the interactive content elements, for which the key maps are set, and a keypad having a selection keypad for receiving the user's input signal to select one of the interactive content elements displayed in the picture.

Although not shown, the user interface unit 230 may further include a speech recognition unit that recognizes the user's speech requesting the picture including the interactive content elements, the key maps of which are set (or selects one of the displayed interactive content elements) and transmits the user's speech to the controller 220.

Upon receiving the user's input signal for selecting one of the interactive content elements from the user interface unit 230 by key inputting or speech recognition, the controller 220 interactively processes the interactive content element selected by key inputting or speech recognition. Then, the picture composition unit 240 makes a picture that provides data obtained according to the processed result and supplies it to the display unit 250 under control of the controller 220.

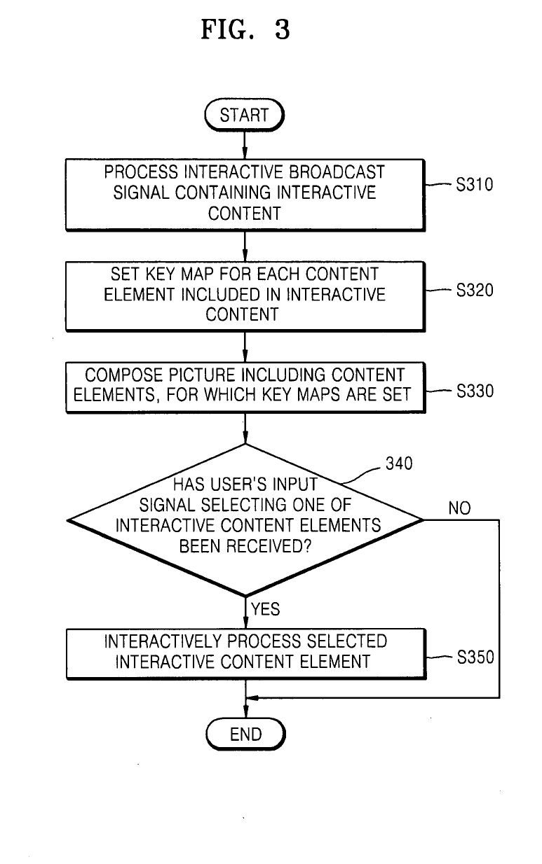

FIG. 3 is a flowchart illustrating a method of providing interactive broadcasting according to an exemplary embodiment of the present invention. Referring to FIGS. 2 and 3, the broadcast signal processor 210 processes an interactive broadcast signal containing interactive content (S310). Next, the picture composition unit 240 sets a key map for each element of the interactive content under control of the controller 220 (S320). In this case, the key maps are set such that the interactive content elements correspond to user input keys included in the user interface unit 230.

Whenever the controller 220 receives a user's input signal requesting a change of a broadcast channel or a broadcast service from the user interface unit 230 or whenever the interactive content for a current broadcast service is changed, the controller 220 may set a key map for each interactive content element. Thus, the key map for each interactive content element may be updated whenever the interactive content elements provided to the user are changed.

Next, the picture composition unit 240 composes a picture that includes the interactive content elements, for which the key maps are set (S330). In the picture, signs corresponding to the user input keys are respectively assigned to the interactive content elements, and displayed. When the user's input signal that selects one of the interactive content elements is received (S340), the interactive content element corresponding to a selected sign is interactively processed (S350).

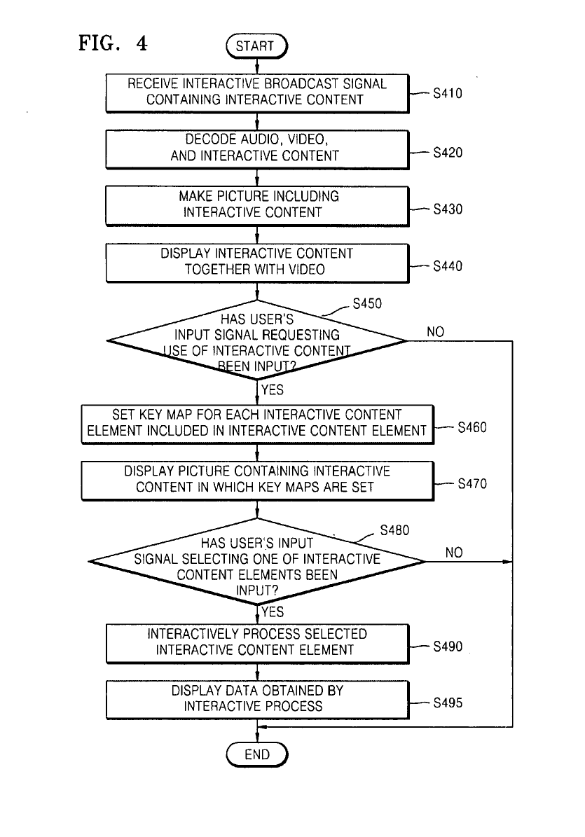

FIG. 4 is a flowchart illustrating a method of providing interactive broadcasting according to another exemplary embodiment of the present invention. Referring to FIGS. 2 and 4, the broadcast signal processor 210 receives an interactive broadcast signal that contains interactive content (S410) and decodes audio, video, and interactive content (S420). Next, the picture composition unit 240 makes a picture that includes the interactive content under control of the controller 220 (S430).

Next, the interactive content is displayed together with the video on the display unit 250 (S440). If the user's input signal requesting use of the interactive content is input using the access button 10 shown in FIG. 1A or by speech recognition (S450), the controller 220 sets a key map for each interactive content element included in the interactive content (S460).

Next, the picture containing the interactive content for which the key maps are set is displayed (S470). When the user's input signal that selects one of the displayed interactive content elements is input by speech recognition, or by key inputting using the selection keypad 20 of FIG. 1B (S480), the controller 220 interactively processes the interactive content element corresponding to a selected sign or number (S490), and outputs data obtained by the interactive process and displays it on the display unit 250 (S495).

The exemplary embodiments of the present invention can be embodied as computer readable code in a computer readable medium. Code and code segments constituting the program can be easily derived by computer programmers skilled in this art. The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the exemplary embodiments of the present invention may be stored and implemented as a computer readable code in the distributed system.

As described above, the exemplary embodiments of the present invention provide a broadcast receiver and method for providing interactive broadcasting by setting a key map for each interactive content element so that interactive broadcasting content can be easily used without a touch screen.

The exemplary embodiments of the present invention also provide a broadcast receiver and method for providing interactive broadcasting by updating a key map for interactive content so that a user can easily determine available interactive content.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A broadcast receiver for providing interactive broadcasting, comprising:
a broadcast signal processor that processes an interactive broadcast signal, which comprises interactive content;
a user interface unit, via which a user's input signal is received;
a controller that sets key maps so that interactive content elements included in the interactive content correspond to user input keys included in the user interface unit; and
a picture composition unit that composes a picture which provides the interactive content under control of the controller,
wherein the picture composition unit assigns signs corresponding to the user input keys to each of the interactive content elements, respectively, and composes the picture including the interactive content elements, for which the key maps are set, and the signs.

2. The broadcast receiving apparatus of claim 1, wherein, when the user's input signal selecting one of the interactive content elements from the user interface unit is received, the controller interactively processes the interactive content element selected in response to the user's input signal.

3. The broadcast receiving apparatus of claim 1, wherein, whenever the user's input signal requesting a change of a broadcast channel or a broadcast service is received from the user interface unit, the controller sets a key map for each of the interactive content elements.

4. The broadcast receiving apparatus of claim 1, wherein, whenever interactive content for a current broadcast service is changed, the controller sets the key map for each of the interactive content elements.

5. The broadcast receiving apparatus of claim 1, wherein the user interface unit comprises:
an access button that receives a user's input signal requesting the picture comprising the interactive content elements, for which the key maps are set; and
a selection keypad that receives a user's input signal selecting one of the interactive content elements included in the picture.

6. The broadcast receiving apparatus of claim 1, wherein the user interface unit comprises a speech recognition unit which recognizes speech in which the picture including the interactive content elements, for which the key maps are set, is requested, or in which one of the interactive content elements included in the picture is requested, and transmits the speech to the controller.

7. A broadcast receiving method of providing interactive broadcasting, comprising:
processing interactive broadcast signals comprising interactive content;
setting key maps so that each of interactive content elements included in the interactive content corresponds to one of user input keys included in the user interface unit; and
composing a picture that includes the interactive content elements, for which the key maps are set, and signs corresponding to the user input keys, which are assigned to the interactive content elements, respectively.

8. The broadcast receiving method of claim 7, when a user's input signal selecting one of the interactive content elements is received, further comprising interactively processing the interactive content element selected in response to the user's input signal.

9. The broadcast receiving method of claim 7, wherein, whenever the user's input signal requesting a change of a broadcast channel or a broadcast service is received, performing the setting of the key maps.

10. The broadcast receiving method of claim 7, wherein, whenever interactive content of a current broadcast service is changed, performing the setting of the key maps.

11. The broadcast receiving method of claim 7, wherein, when the user's input signal requesting use of the interactive content is input, performing the making of the picture comprising the interactive content elements, for which the key maps are set.

12. The broadcast receiving method of claim 7, further comprising recognizing speech which requests the picture comprising the interactive content elements, for which the key maps are set, or selects one of the interactive content elements included in the picture.

13. The broadcast receiving method of claim 8, further comprising displaying data obtained by interactively processing the selected interactive content elements.

14. A computer readable medium having recorded thereon a program for executing the method of claim 7.

15. A computer readable medium having recorded thereon a program for executing the method of claim 8.

16. A computer readable medium having recorded thereon a program for executing the method of claim 9.

17. A computer readable medium having recorded thereon a program for executing the method of claim 10.

18. A computer readable medium having recorded thereon a program for executing the method of claim 11.

19. A computer readable medium having recorded thereon a program for executing the method of claim 12.

20. A computer readable medium having recorded thereon a program for executing the method of claim 13.
